(19) United States
(12) Patent Application Publication
(10) Pub. No.: US 2024/0373311 A1
(43) Pub. Date: Nov. 7, 2024

(54) METHOD AND SYSTEM TO OPTIMIZE LATENCY FOR L1/L2 TRIGGERED MOBILITY

(71) Applicants: RAKUTEN MOBILE USA LLC, San Mateo, CA (US); Rakuten Symphony India Private Limited, Indore, MP (IN)

(72) Inventors: Erdem BALA, San Mateo, CA (US); Subramanya CHANDRASHEKAR, Indore (IN)

(73) Assignees: RAKUTEN MOBILE USA LLC, San Mateo, CA (US); Rakuten Symphony India Private Limited, Indore, MP (IN)

(21) Appl. No.: 18/029,944

(22) PCT Filed: Mar. 2, 2023
(86) PCT No.: PCT/US2023/014333

§ 371 Date: Apr. 3, 2023

(30) Foreign Application Priority Data
Oct. 20, 2022 (IN) 202241060061

(51) Int. Cl. H04W 36/30; H04W 36/00; H04W 36/08; H04W 88/08

(52) U.S. Cl. CPC H04W 36/304; H04W 36/0058; H04W 36/00725; H04W 36/087; H04W 88/085

(57) ABSTRACT

Provided are method, system, and device for configuring inter-cell changes. The method may be implemented by receiving, by a user equipment (UE), a downlink signal, wherein the downlink signal originates from a serving distributed unit (DU), and wherein the downlink signal comprises at least one of a scheduling gap duration value, a start time value, and a target cell index; performing, by the UE during the scheduling gap duration, an uplink sync with a target cell, based on the downlink signal; and wherein the uplink sync includes sending, by the UE, a preamble transmission to a target cell to acquire a timing advance of the target cell, based on the downlink signal, wherein the target DU is one of a plurality of neighboring cells to the serving DU.

### CROSS-REFERENCE TO RELATED APPLICATION

This application claims priority from Indian provisional application IN202241060061 filed on Oct. 20, 2022 in the Indian Patent Office, the entire disclosure of which is incorporated herein by reference for all purposes.

### BACKGROUND

### 1. Field

Systems and methods consistent with example embodiments of the present disclosure relate to optimizing latency in L1/L2 triggered inter-cell changes in disaggregated telecommunications architecture.

### 2. Description of Related Art

A radio access network (RAN) is an important component in a telecommunications system, as it connects end-user devices (or user equipment (UE)) to other parts of the network. The RAN includes a combination of various network elements (NEs) that connect the end-user devices to a core network. Traditionally, hardware and/or software of a particular RAN is vendor specific.

Recently, the evolution of telco technologies enables many telco services to be realized virtually, in the form of software. For instance, RANs such as Open RAN (O-RAN) architectures, disaggregate one network component into multiple functional elements. By way of example, a baseband unit (BBU) or base station (i.e., eNB or gNB) is disaggregated into a number of functional elements including a distributed unit (DU) and a centralized unit (CU), wherein the CU can be further disaggregated into a Centralized Unit-Control Plane (CU-CP) and a Centralized Unit-User Plane (CU-UP). The disaggregation of network elements enables the telco services and the associated functions to be defined and provided in software-based form or virtual network services, such as Virtualized Network Functions (VNFs), Cloud-native Network Functions (CNFs) or Software Defined Networking (SDN), among others.

FIG. 1 illustrates a related art disaggregated gNB architecture in 3GPP. The gNB is disaggregated into multiple logical entities. Two gNB-DU nodes are illustrated, but it can be understood that multiple gNB-DU nodes may be present. It should also be noted that a single DU may host multiple cells. The gNB-DU nodes may communicate with the CU-CP via an F1-C interface, and with the CU-UP via an F1-U interface. The CU-CP and CU-UP may communicate via an E1 interface. The gNB-CU-CP hosts the Packet Data Convergence Protocol (PDCP) and Radio Resource Control (RRC) layers, while the gNB-DU hosts the Radio Link Control (RLC), Medium Access Control (MAC) and Physical (PHY) layers. The scheduling operation takes place at the gNB-DU.

In order to support an L1/L2 centric inter-cell change, since the RLC MAC and PHY layers are located in the gNB-DU, configuration of the cell change should be performed at the gNB-CU-CP whereas the serving cell change should be performed autonomously by the gNB-DU without further interaction with the upper layers. This operation may be referred to herein as L1/L2 triggered mobility (LTM).

Specifically, LTM may be defined as a mobility procedure that allows the network to switch the UE from a source cell to a target cell without necessarily requiring a reconfiguration with sync. In particular, the network, based on L1 measurements received, can indicate in a L2 signaling (e.g., MAC CE) a beam belonging to a LTM candidate cell to which the UE should perform the LTM cell switch procedure. The UE is provided with at least one (or more) LTM candidate cell configuration(s) by the network before the execution of a LTM cell switch procedure.

In the related art, the UE may periodically assess the link quality of the serving cell and the neighbor cells. In order to assess the link quality, the UE may perform measurements (for example, reference signal received power (RSRP) and reference signal received quality (RSRQ) of a Synchronization Signal Block (SSB)) for the serving and neighbor cells relative to the UE. Such measurements may be processed (for example, by L3 filtering) and reported to the serving cell based on a reporting configuration, and if one of the neighboring cells meets a predetermined handover criteria, the serving cell may indicate to the UE that it should handover to that neighboring cell. Subsequently, the UE will use a random access channel (RACH) in the new neighboring cell.

FIG. 2 illustrates a call flow for a typical Layer 3 handover procedure for LTM involving a UE, a source gNB node and a target gNB node (i.e., the gNB-DU nodes mentioned above) according to the related art. Explicit Radio Resource Control (RRC) signaling is required to be triggered in this example, which may result in handover. In a first step, the source gNB node may initiate handover by issuing a handover request (e.g., over an Xn interface). In a second step, the target gNB node may perform admission control, and provide the new RRC configuration by acknowledging (ACKing) the handover request. In a third step, the source gNB node may provide the RRC configuration to the UE by forwarding a RRC Reconfiguration Message received in the handover request ACK. Said RRC Reconfiguration Message may include at least the cell ID, and any information required to access the target cell (which may include beam specific information, if any), such that the UE may access the target cell without reading system information. In some cases, the information required for contention-based random access (CBRA) and contention-free random access (CFRA) may be included in said RRC Reconfiguration Message. In the fourth step, the UE may move the RRC connection to the target gNB node, and reply to the target gNB node with an RRC Reconfiguration Complete message thereafter.

In the related art, another method of managing mobility may include inter-cell beam management (ICBM). Unlike the above method illustrated in FIG. 2, ICBM does not require explicit RRC signaling to be triggered. Instead, for ICBM, a UE may receive or transmit UE dedicated channels/signals via a transmission/reception point (TRP) associated with a physical cell ID (PCI) different from the PCI of a serving cell, while non-UE dedicated channels/signals can only be received via a TRP associated with a PCI of the serving cell. Generally in the related art, the gNB node may provide to the UE (via RRC signaling) measurement configurations which may contain, for example, configurations of the SSB and/or Channel State Information (CSI) resources and/or resource sets, reports, and trigger states for triggering channel and interference measurements and reports. In the case of ICBM, this may be a measurement configuration including SSB resources associated with PCI's different from the PCI of a serving cell. Beam level mobility may then be dealt with at a lower layer by means of physical layer and MAC layer control signaling, and thus the RRC (hosted at the CU-CP) is not required to know which beam is being used by the UE at a given point in time. Other similar methods in the related may include, for example, SSB-based beam level mobility which is based on the SSB associated to the initial downlink bandwidth part (DL BWP), and can only be configured for the initial DL BWPs and DL BWPs containing the SSB associated to the initial DL BWP. For other DL BWPs, beam level mobility may only be performed based on channel state information reference signal (CSI-RS).

In the related art, a possible issue with LTM may arise when the UE has to perform random access channel (RACH) when it hands over to the new cell. Particularly, there may be increased delay caused by latency from a RACH procedure. Specifically, during handover, the UE waits for a physical RACH (PRACH) occasion, and performs RACH to synchronize to the uplink of the target, which is necessitated as the timing advance of the UE at the target cell (which has been configured for handover) may be different from that of the serving cell. Accordingly, the UE would have to wait for the available PRACH occasion, send the preamble, and wait for the random access response (RAR). On average, this may cause 10-20 ms delay from a RACH procedure, which is sub-optimal.

In addition, although methods and systems related to beam based inter-cell mobility (such as ICBM described above) is known in the related art, the related art does not describe how to manage beam based inter-cell mobility with handover. Accordingly, there is a need to optimize/reduce the delay in the handover procedure, while incorporating methods and systems for beam based inter-cell mobility.

### SUMMARY

Example embodiments of the present disclosure provide a method and system for handling L1/L2 triggered mobility (LTM) to reduce mobile latency. Particularly, according to embodiments the scheduling gap duration at the serving cell may be indicated to the user equipment (UE), such that preamble transmission and uplink sync with the target cell (target DU) can be performed during the scheduling gap. Said uplink sync where the UE acquires timing advance of the target cell, as well as the preamble transmission can be made to the target cell, and these findings may be indicated back to the serving cell (serving DU). Accordingly, example embodiments can forego performing a Random Channel Access (RACH) in order to execute a serving cell change (SCC) handover (HO), such that mobile latency is reduced. Furthermore, example embodiments may allow the UE to determine the preferable beams to be used by a neighboring target cell, and indicate the same to the serving cell/DU. Accordingly, the embodiments of the present disclosure may provide a more optimal approach for handling LTM with reduced latency, and allow for beam-based inter-cell mobility.

According to an embodiment, a method for configuring inter-cell changes performed by at least one processor may be provided. The method may include, receiving, by a user equipment (UE), a downlink signal, wherein the downlink signal originates from a serving distributed unit (DU), and wherein the downlink signal comprises at least one of a scheduling gap duration value, a start time value, and a target cell index; performing, by the UE during the scheduling gap duration, an uplink sync with a target cell, based on the downlink signal; and wherein the uplink sync includes sending, by the UE, a preamble transmission to a target cell to acquire a timing advance of the target cell, based on the downlink signal, wherein the target DU is one of a plurality of neighboring cells to the serving DU.

The method may also include acquiring, by the UE, an timing advance to use while transmitting to or receiving from the target cell; and reporting, by the UE, the outcome of the uplink sync and the acquired timing advance to the serving DU.

The preamble transmission and the uplink sync may be performed while the UE is connected to the serving DU. The downlink signal may be one of a Physical Downlink Control Channel (PDCCH) or a MAC Control Element (MAC CE) command.

Performing the measurements based on the downlink signal further comprises performing L1 measurements of the target cell. The method may further include sending, by the UE, the L1 measurements to the serving DU, wherein the serving DU may determine, based on the target cell timing advance reported by the UE, whether to perform a RACH-less LTM handover based on the L1 measurements.

Sending the preamble transmission to the target DU based on the downlink signal may further include: sending, during a scheduling gap duration determined based on the scheduling gap duration value, a random access preamble to the target DU, wherein the target DU may determine a timing advance value for the UE, based on receiving the random access preamble.

The method may further include performing, by the UE, an uplink sync based on the measurements and the preamble transmission; and sending, by the UE, a status signal to the serving DU.

Performing and reporting the L1 measurements is done on one or more target cells aperiodically or based on an event, and wherein the L1 measurements are sent to the serving DU aperiodically . . .

According to an embodiment, an apparatus for configuring inter-cell changes may be provided. The apparatus may include: at least one memory storing computer-executable instructions; and at least one processor configured to execute the computer-executable instructions to: receive, by a user equipment (UE), a downlink signal, wherein the downlink signal originates from a serving distributed unit (DU), and wherein the downlink signal comprises at least one of a scheduling gap duration value, a start time value, and a target cell index; perform, by the UE during the scheduling gap duration, an uplink sync with a target cell, based on the downlink signal; and wherein the uplink sync includes sending, by the UE, a preamble transmission to a target cell to acquire a timing advance of the target cell, based on the downlink signal, wherein the target DU is one of a plurality of neighboring cells to the serving DU

The at least one processor may be further configured to execute the computer-executable instructions to acquire, by the UE, an timing advance to use while transmitting to or receiving from the target cell; and report, by the UE, the outcome of the uplink sync and the acquired timing advance to the serving DU.

The at least one processor may be further configured to execute the computer-executable instructions to perform the measurements based on the downlink signal by performing L1 measurements of the target cell; and the at least one processor may be further configured to execute the computer-executable instructions to: send, by the UE, the L1 measurements to the serving DU, wherein the serving DU may determine, based on the target cell timing advance reported by the UE, whether to perform a RACH-less LTM handover based on the L1 measurements.

The at least one processor may be further configured to execute the computer-executable instructions to send the preamble transmission to the target DU based on the downlink signal by: sending, during a scheduling gap duration determined based on the scheduling gap duration value, a random access preamble to the target DU, wherein the target DU may determine a timing advance value for the UE, based on receiving the random access preamble.

The at least one processor may be further configured to execute the computer-executable instructions to: performing, by the UE, an uplink sync based on the measurements and the preamble transmission; and sending, by the UE, a status signal to the serving DU.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a disaggregated gNB architecture according to the related art;

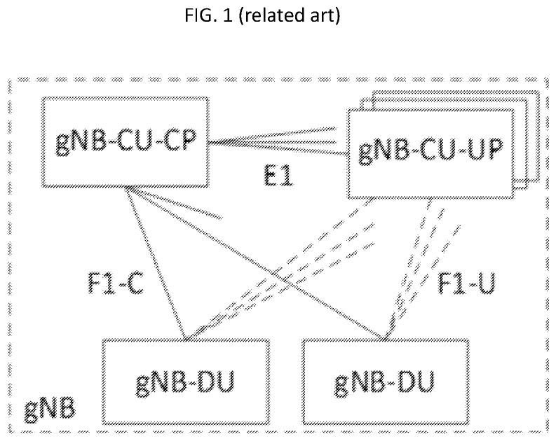

FIG. 2 illustrates a call flow for a typical handover procedure for LTM involving a UE, a source gNB node and a target gNB node according to the related art;

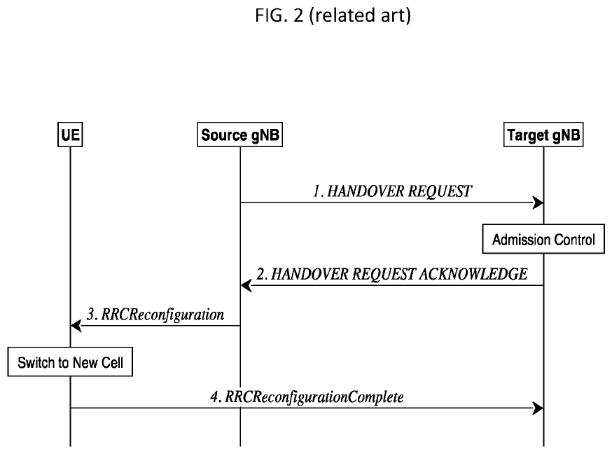

FIG. 3 illustrates an inter-cell mobility scenario according to an embodiment;

FIG. 4 illustrates a handover procedure according to an embodiment;

FIG. 5 is a diagram of an example environment in which systems and/or methods, described herein, may be implemented; and

FIG. 6 is a diagram of example components of a device according to an embodiment.

### DETAILED DESCRIPTION

The following detailed description of example embodiments refers to the accompanying drawings.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Example embodiments of the present disclosure provide a method and system for handling L1/L2 triggered mobility (LTM) to reduce mobile latency. Particularly, according to embodiments the scheduling gap duration at the serving cell may be indicated to the user equipment (UE), such that preamble transmission and uplink sync with the target cell (target DU) can be performed during the scheduling gap. Said uplink sync where the UE acquires timing advance of the target cell, as well as the preamble transmission can be made to the target cell, and these findings may be indicated back to the serving cell (serving DU). Accordingly, example embodiments can forego performing a Random Channel Access (RACH) in order to execute a serving cell change (SCC) handover (HO), such that mobile latency is reduced. Furthermore, example embodiments may allow the UE to determine the preferable beams to be used by a neighboring target cell, and indicate the same to the serving cell/DU.

Accordingly, the embodiments of the present disclosure may provide a more optimal approach for handling LTM with reduced latency, and allow for beam-based inter-cell mobility.

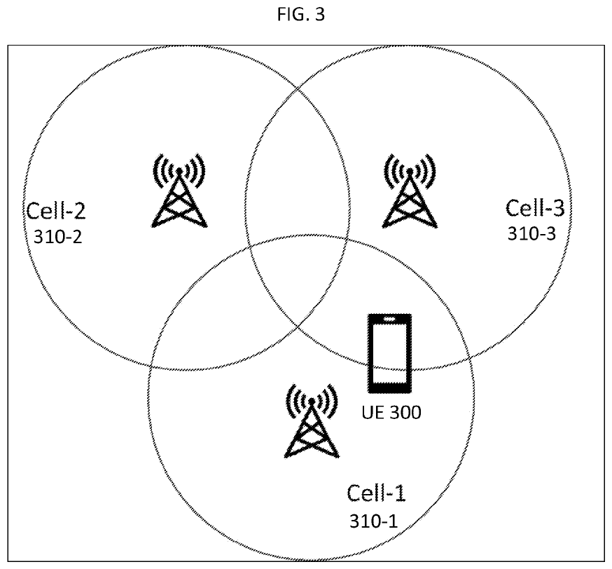

FIG. 3 illustrates an example inter-cell mobility scenario according to one or more embodiments. UE 300 and Cell-1 310-1, Cell-2 310-2, and Cell-3 310-3 are provided. As illustrated in FIG. 3, UE 300 may be located in Cell-1 310-1, which is the serving cell (i.e., the serving DU). Cells-2 310-2 and Cell-3 310-3 may be considered as neighboring cells to Cell-1 310-1.

According to some embodiments, UE 300 may be configured with a measurement configuration, for example, containing configurations to measure SSB and/or CSI-RS resources, physical cell IDs, etc. UE 300 may also be configured with measurement reporting configurations. For example, such reporting configuration may include periodic and aperiodic reporting to the serving cell (e.g., Cell-1 310-1), but it should be appreciated that other schemas and scheduling configurations for reporting can be configured with UE 300. UE 300 may be configured to measure the signal quality of one or more of the cells (i.e., serving cell Cell-1 310-1 and neighboring cells Cell-2 310-2 and Cell-3 310-3).

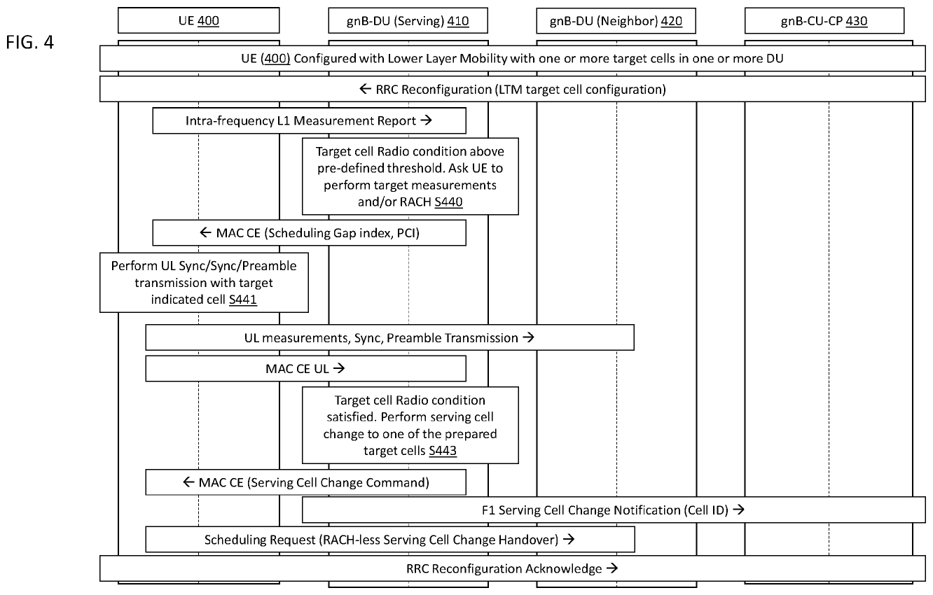

UE 300 may perform the measurements of the cells while being connected to Cell-1 310-1, and UE 300 may perform the measurements of the cells during the scheduling gap indicated by Cell-1 310-1 (the scheduling gap is described in more detail with reference to FIG. 4 below). For inter-frequency measurements, UE 300 may be configured with measurement gaps. In other embodiments, the UE may be dynamically indicated a set of time resources during which it may perform the measurements. The signaling for such indication may be in the form of a Physical Downlink Control Channel (PDCCH) or a MAC Control Element (MAC CE) command.

According to one embodiment, UE 300 may determine the preferable beam(s) to use while transmitting to or receiving from a neighboring cell. UE 300 may also report (e.g., via uplink MAC CE), to serving cell Cell-1 310-1, the preferable beam to be used for that neighboring cell.

According to one embodiment, UE 300 may be configured with a set of triggering states. In particular, each triggering state may contain an offset value. For instance, the offset value may be in slots. Each triggering state may also contain a gap length The triggering states may be configured with RRC and at least one triggering state may be activated or deactivated with a MAC CE. UE 300 may be indicated in the Downlink Control Information (DCI) an index to the triggering state. The offset value may indicate the time at which UE 300 may start performing measurement after a downlink signal (e.g., PDCCH) is received, and the gap value may indicate the length of the gap during which UE 300 may continue performing the measurements. As an example, if the downlink signal is received in slot n, and the triggering state values contain an offset value of L slots and a gap value of M slots, UE 300 may start performing measurements in slot n+L, and end in slot N+L+M−1. UE 300 may also be indicated which cell(s) to measure as part of the triggering state. Alternatively, this may be indicated to UE 300 using another entry in the control information. In yet another embodiment, the offset value and/or the gapu value may be explicitly signaled in the DCI.

According to another embodiment, UE 300 may be configured to receive the timing advance to use for transmission to neighboring cell-2 310-2 and/or cell-3 310-3. This may be done proactively (i.e., prior to a handover request to the neighbor cell being received)

FIG. 4 illustrates an example timing diagram for a SCC/handover procedure according to one or more embodiments. UE 400, Serving DU 410, Target DU 420, and CU-CP 430 may be provided. It should be appreciated that according to embodiments, UE 400 may be similar to UE 300 as described above, and Serving DU 410 may be similar to Cell-1 310-1 as described above. Target DU 420 may be similar to either of Cell-2 310-2 or Cell-2 310-3 as described above. UE 400 may be configured with Lower Layer (L1/L2) triggered mobility (LTM) with one or more target cells in one or more DU's (e.g., target DU 420). CU-CP 430 may send a RRC reconfiguration message to UE 400 to configure LTM in the target cell (target DU 420). UE 400 may then send an intra-frequency L1 measurement report to the serving DU 410.

Referring still to FIG. 4, at operation S440, the serving DU 410 may detect that the target cell radio condition is above the pre-defined threshold. For example, this may be based on the L1 measurement report indicating that the UE 400 has poor radio connection with serving DU 410. Accordingly, serving DU 410 may instruct UE 400 to perform target cell measurements of the target DU 420 and/or uplink sync procedure with target DU 420 cell.

According to one embodiment, the instruction to UE 400 from serving DU 410 may be in the form of a downlink signal. The downlink signal may be in the form of a PDCCH or a MAC CE command. The downlink signal may include a scheduling gap value, a start time value, and a target cell index. Specifically, the scheduling gap is some time in which UE 400 is not scheduled any packets in downlink in all transmission time intervals (TTI's) by a packet scheduler (MAC PS) located in serving DU 410, which is associated with a bearer. The scheduling gap may be in the form of a pre-configured index agreed by any well-known standards (for example, 3GPP RAN2). Accordingly, different scheduling gap values may be represented using different indexes. Based on this information from the downlink signal, UE 400 can perform uplink measurements and/or uplink sync and/or preamble transmission during this scheduling gap. The downlink signal may include the physical cell ID (PCI) of the neighbor cell or an index of the neighbor cell. The PCI and/or the index may be used to determine the resource allocation of the transmission (e.g., UE transmit beam, the preamble index, the random-access time/frequency resources, etc.) Alternatively, downlink signal may not include the PCI or a cell index and it may include an index to a preamble and/or random-access resources.

At operation S441, after receiving the instruction to perform target measurements in operation S440, UE 400 may perform an uplink (UL) sync with target DU 420. The UL sync may include performing L1 measurement (e.g., RSRP and/or the RSRQ) of neighboring target DU 420, and preamble transmission to target DU 420 and acquiring the timing advance of the UE 400 in the target cell. Nevertheless, it should be noted that according to one embodiment, the UL sync can be performed with one or more of the neighboring cells aside from target DU 420. According to another embodiment, the L1 measurements of the neighboring target DU cell 420, the timing advance acquired by UE 400, and the outcome of the uplink sync may be signaled back to serving DU 410 (for example, via MAC CE uplink). This report may be signaled to serving DU 410 periodically or aperiodically (i.e., even based). Based on these measurements, serving DU 410 may instruct the UE to perform RACH-less or RACH-based LTM handover/serving cell change (SCC) to the target DU 420 (operation S443, as discussed in further detail below). UE 400 may also inform serving DU 410 whether or not the UL sync and/or preamble transmission was successful (e.g., by sending a status signal). According to yet another embodiment, UE 400 may proactively send, during the scheduling gap, a random access preamble of the indicated target DU 420, so that target DU 420 can determine a timing advance. Serving DU 410 may send the timing advance and the index of the cell corresponding to the timing advance to UE 400. The timing advance information of the UE 400 may also be sent from the target DU 420 to the serving DU 410, e.g., through CU-CP 430 (it should be noted that in this case, the serving DU 410 and the target neighbor cells are assumed to be associated with different gNB-DUs served by the same gNB-CU) or directly over a DU-DU interface, if available.

According to one embodiment, UE 400 may request from serving DU 410, a timing advance alignment applicable to the UE at target DU 420. The request may be sent to serving DU 410 in a MAC CE. The request may include the PCI and/or index of target DU 420. Serving DU 410 may either send a timing advance value to UE 400 that is applicable to the neighbor cell or may indicate to UE 400 to start the procedure disclosed above to get the timing advance value (e.g., when serving DU 410 does not have the timing advance value or if the value is outdated).

UE 400 may have been configured with random access resources prior to this operation (e.g., during target cell preparation), and these random access resources may be allocated exclusively to transmit said random-access preamble to a target DU 420. The resource configuration may include, but is not limited to, a preamble index, time/frequency resources (e.g., symbol/slot index, resource block (RB) index), transmit power, etc. The above measurements and preamble transmission may be performed while UE 400 maintains an RRC connection to serving DU 410.

At operation S443, the serving DU 410 may determine (for example, based on the L1 measurement of target DU 420) that a serving cell change radio condition is satisfied. Accordingly, serving DU 410 may instruct UE 400 to perform SCC handover to target DU 420. According to an embodiment, this instruction may be sent via a MAC CE command. It should be appreciated that the system information of target DU 420 may already be available for use by UE 400 (e.g., from a previous configuration sent earlier prior to the procedure). The serving DU 410 may also notify CU-CP 430 via a F1 message of the change. Since UE 400 has already acquired the timing advance of the target cell, it does not need to perform RACH, and it may send a scheduling request directly to target DU 420. According to an embodiment, the scheduling request may utilize a previously acquired timing advance. The scheduling request configuration may also be available at UE 400 from a previous configuration by serving DU 410. Thus, when UE 400 moves to target DU 420, target DU 420 may use the preferable beam to transmit to the UE, since this information may have been shared by serving DU 410. Similarly, UE 400 may also use the preferable/optimal transmit/receive beams. In an alternate embodiment, it should be appreciated that UE 400 may instead send an RRC configuration request to target DU 420. In this alternate embodiment, the resource allocation for the RRC configuration message may already be available at UE 400 from a previous configuration by serving DU 410.

The above embodiments can accordingly forego performing RACH in order to execute SCC/HO such that mobile latency is reduced. Furthermore, example embodiments may allow the UE to determine the preferable beams to be used by a neighboring target cell, and indicate the same to the serving cell. Thus, the embodiments of the present disclosure may provide a more optimal approach for handling LTM with reduced latency, and allow for beam-based inter-cell mobility.

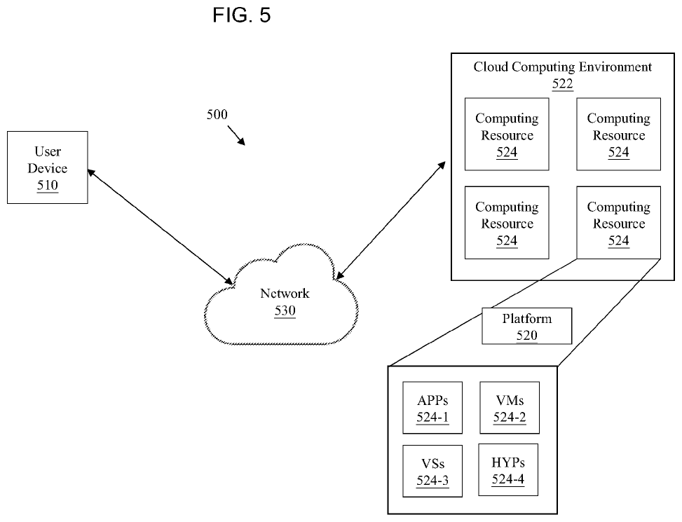

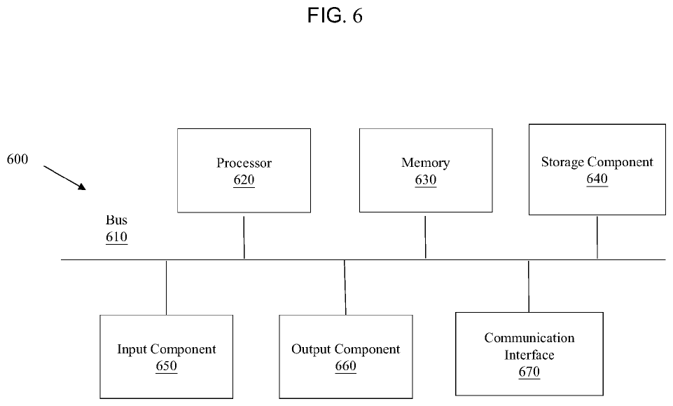

FIG. 5 is a diagram of an example environment 500 in which systems and/or methods, described herein, may be implemented. As shown in FIG. 5, environment 500 may include a user device 510, a platform 520, and a network 530. Devices of environment 500 may interconnect via wired connections, wireless connections, or a combination of wired and wireless connections. In embodiments, any of the functions and operations described with reference to FIGS. 6 through 7 above may be performed by any combination of elements illustrated in FIG. 5.

User device 510 includes one or more devices capable of receiving, generating, storing, processing, and/or providing information associated with platform 520. For example, user device 510 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 510 may receive information from and/or transmit information to platform 520.

Platform 520 includes one or more devices capable of receiving, generating, storing, processing, and/or providing information. In some implementations, platform 520 may include a cloud server or a group of cloud servers. In some implementations, platform 520 may be designed to be modular such that certain software components may be swapped in or out depending on a particular need. As such, platform 520 may be easily and/or quickly reconfigured for different uses.

In some implementations, as shown, platform 520 may be hosted in cloud computing environment 522. Notably, while implementations described herein describe platform 520 as being hosted in cloud computing environment 522, in some implementations, platform 520 may not be cloud-based (i.e., may be implemented outside of a cloud computing environment) or may be partially cloud-based.

Cloud computing environment 522 includes an environment that hosts platform 520. Cloud computing environment 522 may provide computation, software, data access, storage, etc., services that do not require end-user (e.g., user device 510) knowledge of a physical location and configuration of system(s) and/or device(s) that hosts platform 520. As shown, cloud computing environment 522 may include a group of computing resources 524 (referred to collectively as “computing resources 524” and individually as “computing resource 524”).

Computing resource 524 includes one or more personal computers, a cluster of computing devices, workstation computers, server devices, or other types of computation and/or communication devices. In some implementations, computing resource 524 may host platform 520. The cloud resources may include compute instances executing in computing resource 524, storage devices provided in computing resource 524, data transfer devices provided by computing resource 524, etc. In some implementations, computing resource 524 may communicate with other computing resources 524 via wired connections, wireless connections, or a combination of wired and wireless connections.

As further shown in FIG. 5, computing resource 524 includes a group of cloud resources, such as one or more applications (“APPs”) 524-1, one or more virtual machines (“VMs”) 524-2, virtualized storage (“VSs”) 524-3, one or more hypervisors (“HYPs”) 524-4, or the like.

Application 524-1 includes one or more software applications that may be provided to or accessed by user device 510. Application 524-1 may eliminate a need to install and execute the software applications on user device 510. For example, application 524-1 may include software associated with platform 520 and/or any other software capable of being provided via cloud computing environment 522. In some implementations, one application 524-1 may send/receive information to/from one or more other applications 524-1, via virtual machine 524-2.

Virtual machine 524-2 includes a software implementation of a machine (e.g., a computer) that executes programs like a physical machine. Virtual machine 524-2 may be either a system virtual machine or a process virtual machine, depending upon use and degree of correspondence to any real machine by virtual machine 524-2. A system virtual machine may provide a complete system platform that supports execution of a complete operating system (“OS”). A process virtual machine may execute a single program, and may support a single process. In some implementations, virtual machine 524-2 may execute on behalf of a user (e.g., user device 510), and may manage infrastructure of cloud computing environment 522, such as data management, synchronization, or long-duration data transfers.

Virtualized storage 524-3 includes one or more storage systems and/or one or more devices that use virtualization techniques within the storage systems or devices of computing resource 524. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 524-4 may provide hardware virtualization techniques that allow multiple operating systems (e.g., “guest operating systems”) to execute concurrently on a host computer, such as computing resource 524. Hypervisor 524-4 may present a virtual operating platform to the guest operating systems, and may manage the execution of the guest operating systems. Multiple instances of a variety of operating systems may share virtualized hardware resources.

Network 530 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600. Device 600 may correspond to user device 510 and/or platform 520. As shown in FIG. 6, device 600 may include a bus 610, a processor 620, a memory 630, a storage component 640, an input component 650, an output component 660, and a communication interface 670.

Bus 610 includes a component that permits communication among the components of device 600. Processor 620 may be implemented in hardware, firmware, or a combination of hardware and software. Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 includes one or more processors capable of being programmed to perform a function. Memory 630 includes a random access memory (RAM), a read only memory (ROM), and/or another type of dynamic or static storage device (e.g., a flash memory, a magnetic memory, and/or an optical memory) that stores information and/or instructions for use by processor 620.

Storage component 640 stores information and/or software related to the operation and use of device 600. For example, storage component 640 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 650 includes a component that permits device 600 to receive information, such as via user input (e.g., a touch screen display, a keyboard, a keypad, a mouse, a button, a switch, and/or a microphone). Additionally, or alternatively, input component 650 may include a sensor for sensing information (e.g., a global positioning system (GPS) component, an accelerometer, a gyroscope, and/or an actuator). Output component 660 includes a component that provides output information from device 600 (e.g., a display, a speaker, and/or one or more light-emitting diodes (LEDs)).

Communication interface 670 includes a transceiver-like component (e.g., a transceiver and/or a separate receiver and transmitter) that enables device 600 to communicate with other devices, such as via a wired connection, a wireless connection, or a combination of wired and wireless connections. Communication interface 670 may permit device 600 to receive information from another device and/or provide information to another device. For example, communication interface 670 may include an Ethernet interface, an optical interface, a coaxial interface, an infrared interface, a radio frequency (RF) interface, a universal serial bus (USB) interface, a Wi-Fi interface, a cellular network interface, or the like.

Device 600 may perform one or more processes described herein. Device 600 may perform these processes in response to processor 620 executing software instructions stored by a non-transitory computer-readable medium, such as memory 630 and/or storage component 640. A computer-readable medium is defined herein as a non-transitory memory device. A memory device includes memory space within a single physical storage device or memory space spread across multiple physical storage devices.

Software instructions may be read into memory 630 and/or storage component 640 from another computer-readable medium or from another device via communication interface 670. When executed, software instructions stored in memory 630 and/or storage component 640 may cause processor 620 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

In embodiments, any one of the operations or processes of FIG. 4 may be implemented by or using any one of the elements illustrated in FIGS. 5 and 6. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

### Various Aspects of Embodiments

Various further respective aspects and features of embodiments of the present disclosure may be defined by the following items:
Item [1]: A method, performed by at least one processor, for configuring inter-cell changes, the method comprising: receiving, by a user equipment (UE), a downlink signal, wherein the downlink signal originates from a serving distributed unit (DU), and wherein the downlink signal comprises at least one of a scheduling gap duration value, a start time value, and a target cell index; performing, by the UE during the scheduling gap duration, an uplink sync with a target cell, based on the downlink signal; and wherein the uplink sync includes sending, by the UE, a preamble transmission to a target cell to acquire a timing advance of the target cell, based on the downlink signal, wherein the target DU is one of a plurality of neighboring cells to the serving DU.
Item [2]: The method according to item [1], wherein the method further comprises: acquiring, by the UE, an timing advance to use while transmitting to or receiving from the target cell; and reporting, by the UE, the outcome of the uplink sync and the acquired timing advance to the serving DU.
Item [3]: The method according to any one of items [1]-[2], wherein the preamble transmission and the uplink sync are performed while the UE is connected to the serving DU.
Item [4]: The method according to any one of items [1]-[3], wherein the downlink signal is one of a Physical Downlink Control Channel (PDCCH) or a MAC Control Element (MAC CE) command.
Item [5]: The method according to any one of items [1]-[4], wherein performing the measurements based on the downlink signal further comprises performing L1 measurements of the target cell; and wherein the method further comprises: sending, by the UE, the L1 measurements to the serving DU, wherein the serving DU may determine, based on the target cell timing advance reported by the UE, whether to perform a RACH-less LTM handover based on the L1 measurements.
Item [6]. The method according to item [5], wherein sending the preamble transmission to the target DU based on the downlink signal further comprises: sending, during a scheduling gap duration determined based on the scheduling gap duration value, a random access preamble to the target DU, wherein the target DU may determine a timing advance value for the UE, based on receiving the random access preamble.
Item [7]: The method according to any one of items [1]-[6], wherein the method further comprises: performing, by the UE, an uplink sync based on the measurements and the preamble transmission; and sending, by the UE, a status signal to the serving DU.
Item [8]: The method according to any one of items [5]-[6], wherein performing and reporting the L1 measurements is done on one or more target cells aperiodically or based on an event, and wherein the L1 measurements are sent to the serving DU aperiodically . . .
Item [9]: An apparatus for configuring inter-cell changes, the apparatus comprising: at least one memory storing computer-executable instructions; and at least one processor configured to execute the computer-executable instructions to: receive, by a user equipment (UE), a downlink signal, wherein the downlink signal originates from a serving distributed unit (DU), and wherein the downlink signal comprises at least one of a scheduling gap duration value, a start time value, and a target cell index; perform, by the UE during the scheduling gap duration, an uplink sync with a target cell, based on the downlink signal; and wherein the uplink sync includes sending, by the UE, a preamble transmission to a target cell to acquire a timing advance of the target cell, based on the downlink signal, wherein the target DU is one of a plurality of neighboring cells to the serving DU
Item [10]: The apparatus according to item [9], wherein the at least one processor is further configured to execute the computer-executable instructions to acquire, by the UE, an timing advance to use while transmitting to or receiving from the target cell; and report, by the UE, the outcome of the uplink sync and the acquired timing advance to the serving DU.
Item [11]: The apparatus according to any one of items [9]-[10], wherein the preamble transmission and the uplink sync are performed while the UE is connected to the serving DU.
Item [12]: The apparatus according to any one of items [9]-[11], wherein the downlink signal is one of a Physical Downlink Control Channel (PDCCH) or a MAC Control Element (MAC CE) command.
Item [13]: The apparatus according to any one of items [9]-[12], wherein the at least one processor is further configured to execute the computer-executable instructions to perform the measurements based on the downlink signal by performing L1 measurements of the target cell; and wherein the at least one processor is further configured to execute the computer-executable instructions to: send, by the UE, the L1 measurements to the serving DU, wherein the serving DU may determine, based on the target cell timing advance reported by the UE, whether to perform a RACH-less LTM handover based on the L1 measurements.
Item [14]: The apparatus according to item [13], wherein the at least one processor is further configured to execute the computer-executable instructions to send the preamble transmission to the target DU based on the downlink signal by: sending, during a scheduling gap duration determined based on the scheduling gap duration value, a random access preamble to the target DU, wherein the target DU may determine a timing advance value for the UE, based on receiving the random access preamble.
Item [15]: The apparatus according to any one of items [9]-[14], wherein the at least one processor is further configured to execute the computer-executable instructions to: performing, by the UE, an uplink sync based on the measurements and the preamble transmission; and sending, by the UE, a status signal to the serving DU.
Item [16]: The apparatus according to any one of items [13]-[14], wherein performing and reporting the L1 measurements is done on one or more target cells aperiodically or based on an event, and wherein the L1 measurements are sent to the serving DU aperiodically.
Item [17]: A non-transitory computer-readable recording medium having recorded thereon instructions executable by at least one processor to cause the at least one processor to perform a method comprising: receiving, by a user equipment (UE), a downlink signal, wherein the downlink signal originates from a serving distributed unit (DU), and wherein the downlink signal comprises at least one of a scheduling gap duration value, a start time value, and a target cell index; performing, by the UE during the scheduling gap duration, an uplink sync with a target cell, based on the downlink signal; and wherein the uplink sync includes sending, by the UE, a preamble transmission to a target cell to acquire a timing advance of the target cell, based on the downlink signal, wherein the target DU is one of a plurality of neighboring cells to the serving DU.
Item [18]: The non-transitory computer-readable recording medium according to item [17], wherein the method further comprises: acquiring, by the UE, an timing advance to use while transmitting to or receiving from the target cell; and reporting, by the UE, the outcome of the uplink sync and the acquired timing advance to the serving DU.
Item [19]: The non-transitory computer-readable recording medium according to any one of items [17]-[18], wherein performing the measurements based on the downlink signal further comprises performing L1 measurements of the target cell; and wherein the method further comprises: sending, by the UE, the L1 measurements to the serving DU, wherein the serving DU may determine, based on the target cell timing advance reported by the UE, whether to perform a RACH-less LTM handover based on the L1 measurements.
Item [20]: The non-transitory computer-readable recording medium according to item [19], wherein sending the preamble transmission to the target DU based on the downlink signal further comprises: sending, during a scheduling gap duration determined based on the scheduling gap duration value, a random access preamble to the target DU, wherein the target DU may determine a timing advance value for the UE, based on receiving the random access preamble.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method, performed by at least one processor, for configuring inter-cell changes, the method comprising:
receiving, by a user equipment (UE), a downlink signal, wherein the downlink signal originates from a serving distributed unit (DU), and wherein the downlink signal comprises at least one of a scheduling gap duration value, a start time value, and a target cell index;
performing, by the UE during the scheduling gap duration, an uplink sync with a target cell, based on the downlink signal; and
wherein the uplink sync includes sending, by the UE, a preamble transmission to a target cell to acquire a timing advance of the target cell, based on the downlink signal, wherein the target DU is one of a plurality of neighboring cells to the serving DU.

2. The method as claimed in claim 1, wherein the method further comprises:
acquiring, by the UE, an timing advance to use while transmitting to or receiving from the target cell; and
reporting, by the UE, the outcome of the uplink sync and the acquired timing advance to the serving DU.

3. The method as claimed in claim 1, wherein the preamble transmission and the uplink sync are performed while the UE is connected to the serving DU.

4. The method as claimed in claim 1, wherein the downlink signal is one of a Physical Downlink Control Channel (PDCCH) or a MAC Control Element (MAC CE) command.

5. The method as claimed in claim 1, wherein performing the measurements based on the downlink signal further comprises performing L1 measurements of the target cell; and wherein the method further comprises:
sending, by the UE, the L1 measurements to the serving DU, wherein the serving DU may determine, based on the target cell timing advance reported by the UE, whether to perform a RACH-less LTM handover based on the L1 measurements.

6. The method as claimed in claim 5, wherein sending the preamble transmission to the target DU based on the downlink signal further comprises:
sending, during a scheduling gap duration determined based on the scheduling gap duration value, a random access preamble to the target DU, wherein the target DU may determine a timing advance value for the UE, based on receiving the random access preamble.

7. The method as claimed in claim 1, wherein the method further comprises:
performing, by the UE, an uplink sync based on the measurements and the preamble transmission; and
sending, by the UE, a status signal to the serving DU.

8. The method as claimed in claim 5, wherein performing and reporting the L1 measurements is done on one or more target cells aperiodically or based on an event, and wherein the L1 measurements are sent to the serving DU aperiodically.

9. An apparatus for configuring inter-cell changes, the apparatus comprising:
at least one memory storing computer-executable instructions; and
at least one processor configured to execute the computer-executable instructions to:
receive, by a user equipment (UE), a downlink signal, wherein the downlink signal originates from a serving distributed unit (DU), and wherein the downlink signal comprises at least one of a scheduling gap duration value, a start time value, and a target cell index;
perform, by the UE during the scheduling gap duration, an uplink sync with a target cell, based on the downlink signal; and
wherein the uplink sync includes sending, by the UE, a preamble transmission to a target cell to acquire a timing advance of the target cell, based on the downlink signal, wherein the target DU is one of a plurality of neighboring cells to the serving DU

10. The apparatus as claimed in claim 9, wherein the at least one processor is further configured to execute the computer-executable instructions to acquire, by the UE, an timing advance to use while transmitting to or receiving from the target cell; and
report, by the UE, the outcome of the uplink sync and the acquired timing advance to the serving DU.

11. The apparatus as claimed in claim 9, wherein the preamble transmission and the uplink sync are performed while the UE is connected to the serving DU.

12. The apparatus as claimed in claim 9, wherein the downlink signal is one of a Physical Downlink Control Channel (PDCCH) or a MAC Control Element (MAC CE) command.

13. The apparatus as claimed in claim 9, wherein the at least one processor is further configured to execute the computer-executable instructions to perform the measurements based on the downlink signal by performing L1 measurements of the target cell; and wherein the at least one processor is further configured to execute the computer-executable instructions to:
send, by the UE, the L1 measurements to the serving DU, wherein the serving DU may determine, based on the target cell timing advance reported by the UE, whether to perform a RACH-less LTM handover based on the L1 measurements.

14. The apparatus as claimed in claim 13, wherein the at least one processor is further configured to execute the computer-executable instructions to send the preamble transmission to the target DU based on the downlink signal by:
sending, during a scheduling gap duration determined based on the scheduling gap duration value, a random access preamble to the target DU, wherein the target DU may determine a timing advance value for the UE, based on receiving the random access preamble.

15. The apparatus as claimed in claim 9, wherein the at least one processor is further configured to execute the computer-executable instructions to:
performing, by the UE, an uplink sync based on the measurements and the preamble transmission; and
sending, by the UE, a status signal to the serving DU.

16. The apparatus as claimed in claim 13, wherein performing and reporting the L1 measurements is done on one or more target cells aperiodically or based on an event, and wherein the L1 measurements are sent to the serving DU aperiodically.

17. A non-transitory computer-readable recording medium having recorded thereon instructions executable by at least one processor to cause the at least one processor to perform a method comprising:
receiving, by a user equipment (UE), a downlink signal, wherein the downlink signal originates from a serving distributed unit (DU), and wherein the downlink signal comprises at least one of a scheduling gap duration value, a start time value, and a target cell index;
performing, by the UE during the scheduling gap duration, an uplink sync with a target cell, based on the downlink signal; and
wherein the uplink sync includes sending, by the UE, a preamble transmission to a target cell to acquire a timing advance of the target cell, based on the downlink signal, wherein the target DU is one of a plurality of neighboring cells to the serving DU.

18. The non-transitory computer-readable recording medium as claimed in claim 17, wherein the method further comprises:
acquiring, by the UE, an timing advance to use while transmitting to or receiving from the targetcell; and
reporting, by the UE, the outcome of the uplink sync and the acquired timing advance to the serving DU.

19. The non-transitory computer-readable recording medium as claimed in claim 17, wherein performing the measurements based on the downlink signal further comprises performing L1 measurements of the target cell; and wherein the method further comprises:
sending, by the UE, the L1 measurements to the serving DU, wherein the serving DU may determine, based on the target cell timing advance reported by the UE, whether to perform a RACH-less LTM handover based on the L1 measurements.

20. The non-transitory computer-readable recording medium as claimed in claim 19, wherein sending the preamble transmission to the target DU based on the downlink signal further comprises:
sending, during a scheduling gap duration determined based on the scheduling gap duration value, a random access preamble to the target DU, wherein the target DU may determine a timing advance value for the UE, based on receiving the random access preamble.
